(19) United States
(12) Patent Application Publication
(10) Pub. No.: US 2011/0166821 A1
(43) Pub. Date: Jul. 7, 2011

(54) System and method for analysis of ice skating motion

(76) Inventor: Jack T. B. Kim, San Jose, CA (US)

(21) Appl. No.: 12/655,477

(22) Filed: Jan. 4, 2010

(51) Int. Cl. G06F 15/00; G01P 15/02

(52) U.S. Cl. 702/141; 702/150

(57) ABSTRACT

A processing means and method for obtaining and processing movement data and/or orientation data from one or both ice skates, for an ice skater, while the ice skater is skating. The means and method further recite the use of historical data regarding preferred hockey skating techniques for comparison with the movement data and/or orientation data.

### FIELD OF INVENTION

This invention relates generally to the field of evaluating the athletic skills of an individual. More particularly, the present invention relates to the evaluation of the ice skating skills of hockey players. The present invention allows the motion and orientation of an ice skate to be accurately evaluated.

### CROSS-REFERENCES

None

### STATEMENT REGARDING THE USE OF FEDERAL FUNDS

No federal funding, direct or indirect, has been utilized in conjunction with the development of the present invention.

### PRIOR ART

No prior art can be found which discloses the present invention. However, given the numerous attempts to adequately document and analyze athletic performances using inertial sensors, accelerometers, video cameras and computers, is proper to comment in detail upon issued patents which attempt to quantify various aspects of athletic performances.

Referring now to U.S. Pat. No. 7,264,554 by Bentley, the disclosure is of a system and method for the analysis of the motion of a golf club employing inertial sensors and video cameras monitoring the movement. The orientation of the hands and of the club are not monitored by this system and method. The application disclosed therefore is remote from and does not teach the present invention.

Referring now to U.S. Pat. No. 7,359,121, U.S. Pat. No. 7,038,855 and U.S. Pat. No. 6,430,997, all by French, et al, the disclosure is of a system and method for cuing a player as to the actions of a virtual opponent. The disclosure is not of systems or methods for analyzing motion. The applications disclosed therefore are remote from and does not teach the present invention.

Referring now to U.S. Pat. No. 7,457,724, U.S. Pat. No. 7,072,789 and U.S. Pat. No. 6,959,259, all by Vock, et al, the disclosure is of systems and methods regarding overall performance of a person with regard to distances traveled and the speed of travel. The disclosures are not of systems or methods for analyzing motion.

Referring now to U.S. Pat. No. 7,512,515 by Vock, et al and which is incorporated by reference herein in its entirety, the disclosure is of a general approach and does not deal with or disclose the specific means or method of the present invention.

The cited applications are remote from and do not teach the present invention.

### SUMMARY OF THE INVENTION

The present invention is an improved means and method for acquiring and analyzing data regarding the motions of one or both ice skates when they are being worn and used by an ice skater and, more particularly, by a hockey player.

The sport of ice hockey involves addressing special considerations when evaluating a player's performance. Currently the best practice available for evlauating the ice skating techniques of hockey players is to use an accelerometer affixed to an ice skate in conjunction with high speed video cameras. The results are far from satisfactory and the end result is that a subjective evaluation is required. Further, there tends to be a substantial excess of unwanted data, both from the accelerometer and from the video cameras. These techniques are currently being used by the top professional coaches and consultants for professional hockey players and teams; they have been in use for more than a decade.

The present invention solves this problem by utilizing the information in the form of a three dimensional closed loop, defined as a leaf trace, which represents the movement of the ice skate during a power stroke. A power stroke is defined as the circular motion of an ice skate to the side which results in the increase of the forward velocity of an ice skater. Additional factors which assist in this evaluation is the capture of data for determining the (1) velocity, acceleration and deceleration of the ice skate along the leaf trace and/or (2) the spatial orientation of the ice stake as it creates the leaf trace. It is the determination of the actual shape of the leaf trace in three dimensions that is critical. Professional coaches and consultants concur that there is only one correct leaf trace for an ice skate used by a hockey layer that provides an optimum result. Currently there are no analytic tools available to acquire this information and to compare it with a correct leaf trace.

It is an object of the present invention to provide an improved means and method for acquiring data and for correlating data regarding the motion of one or both ice skates, when they are being worn and used to skate by a skater.

It is a further object of the present invention to provide an improved means and method for determining motion data for one ice skate relative to the other when they are being worn and used by a skater by acquiring and processing information to provide a leaf trace of an ice skater's power stroke.

It is a further object of the present invention to provide means to evaluate a leaf trace and/or the orientation of the ice skate as a leaf trace is created. It is further object of the present invention to provide an improved means and method for comparing motion data for an ice skate with relevant historical motion data, that is, with a correct leaf trace.

These and other objects and advantages of the present invention will become clear to those skilled in the art in view of the description of the best presently known mode of carrying out the invention and the applicability of the preferred embodiment as described here in and as illustrated in the several figures of the drawings.

### BRIEF DESCRIPTION OF THE DRAWINGS

FIG. 1 shows a schematic side view of an ice skate worn by an ice skater with an attached transducer and processor according to the present invention.

FIG. 2 shows a schematic drawing of a processor connected to two transducers, one each affixed to an ice skate.

FIGS. 3A and 3B respectively show schematic top and rear views of the positional trace of an ice skate on a right foot of a user, a leaf trace, during a power stroke.

FIG. 4 shows a schematic flow diagram of the data flow of user data derived from an ice skate according to the present invention.

FIG. 5A shows a plan view of a user leaf trace for an ice skate worn on the right foot.

FIG. 5B shows a plan view of a correct leaf trace for an ice skate worn on the right foot.

FIG. 5C shows a plan view of a correct leaf trace and a user leaf trace for an ice skate worn on the right foot.

FIG. 6A shows a rear view of a user leaf trace of an ice skate worn on the right foot.

FIG. 6B shows a rear view of a correct leaf trace of an ice skate worn on the right foot.

FIG. 6C shows a rear view of a correct leaf trace and a user leaf trace of an ice skate worn on the right foot.

FIG. 7A shows a vector diagram of the absolute position of an ice skate, at a point along a user leaf trace, of the ice skate when worn on the right foot of a user during a power stroke.

FIG. 7B shows a vector diagram of the absolute position of an ice skate, at a point along a correct leaf trace, of the ice skate when worn on the right foot of a user during a power stroke.

FIG. 7C shows a vector diagram of the difference in absolute position of an ice skate, at a point along a leaf trace, between a user leaf trace and a correct leaf trace for the ice skate when worn on the right foot of a user during a power stroke.

FIG. 8A shows a vector diagram of the velocity of an ice skate, at a point along a user leaf trace, of the ice skate when worn on the right foot of a user during a power stroke.

FIG. 8B shows a vector diagram of the velocity of an ice skate, at a point along a correct leaf trace, of the ice skate when worn on the right foot of a user during a power stroke.

FIG. 8C shows a vector diagram of the difference in velocity of an ice skate, at a point along a leaf trace, between a user leaf trace and a correct leaf trace for the ice skate when worn on the right foot of a user during a power stroke.

FIG. 9A shows a vector diagram of the acceleration of an ice skate, at a point along a user leaf trace, of the ice skate when worn on the right foot of a user during a power stroke.

FIG. 9B shows a vector diagram of the acceleration of an ice skate, at a point along a correct leaf trace, of the ice skate worn on the right foot of a user during a power stroke.

FIG. 9C shows a vector diagram of the difference in acceleration of an ice skate, at a point along a leaf trace, between a user leaf trace and a correct leaf trace for the ice skate when worn on the right foot of a user during a power stroke.

FIG. 10A shows a vector diagram of the orientation of an ice skate, at a point along a user leaf trace, of the ice skate when worn on the right foot of a user during a power stroke.

FIG. 10B shows a vector diagram of the orientation of an ice skate, at a point along a correct leaf trace, of the ice skate when worn on the right foot of a user during a power stroke.

FIG. 10C shows a vector diagram of the difference in the orientaiton of an ice skate, at a point along a leaf trace, between a user leaf trace and a correct leaf trace for the ice skate when worn on the right foot of a user during a power stroke.

FIG. 11 shows a single vector in three dimensions.

### PREFERRED EMBODIMENT OF THE PRESENT INVENTION

The preferred means and method for implementing the present invention is the means and method set out herein below.

### BACKGROUND OF THE INVENTION

Athletic and clinical testing for performance analysis and enhancement has traditionally been performed in the laboratory where the required instrumentation is available and environmental conditions can be easily controlled. In this environment dynamic characteristics of athletes are assessed using treadmills, rowing and cycling machines and even flumes for swimmers. In general these machines allow for the monitoring of athletes using instrumentation that cannot be used in the training environment but instead requires the athlete to remain quasi static thus enabling a constant field of view for optical devices and relatively constant proximity for tethered electronic sensors, breath gas analys is etc. Today however by taking advantage of the advancements in microelectronics and other micro technologies it is possible to build instrumentation that is small enough to be unobtrusive for a number of sporting and clinical applications (James, Davey and Rice 2004). One such technology that has seen rapid development in recent years is in the area of inertial sensors. These sensors respond to minute changes in inertia in the linear and radial directions. These are known as accelerometers and rate gyroscopes respectively. This work will focus on the use of accelerometers, though in recent years rate gyroscopes are becoming more popular as they achieve mass-market penetration, thus increasing availability and decreasing cost and device size.

Accelerometers have in recent years shrunk dramatically in size as well as in cost (˜$US20). This has been due chiefly to the adoption by industries such as the auto-mobile industry where they are deployed in airbag systems to detect crashes. Micro electromechanical systems (MEMS) based accelerometers like the ADXLxxx series from Analogue Devices (Weinberg, 1999) are today widely available at low cost. The use of accelerometers to measure activity levels for sporting (Montoye, Washburn, Smais and Ertl 1983), health and for gait analysis (Moe-Nilssen, Nene and Veltink 2004) is emerging as a popular method of bio mechanical quantification of health and sporting activity and set to become more so with the availability of portable computing, storage and battery power available due to the development of consumer products like cell phones, portable music players etc.

Accelerometers measure acceleration at the sensor itself and typically in one or more axis and are millimetres or smaller in size. In general a suspended mass is created in the design and has at least one degree of freedom. The suspended inertial mass is thus susceptible to displacement in at least one plane of movement. These displacements arise from changes in inertia and thus any acceleration in this direction. Construction of these devices vary but typically use a suspended silicon mass on the end of a silicon arm that has been acid etched away from the main body of silicon. The force on the silicon arm can be measured with piezoresistive elements embedded in the arm. In recent years multiple accelerometers have been packaged together orthogonally to offer multi-axis accelerometry. Accelerometers measure the time derivative of velocity and velocity is the time derivative of position. Thus accelerometers can measure the dynamics of motion and potentially position as well. It is well understood though that the determination of position from acceleration alone is a difficult and complex task (Davey and James 2003).

Instead, accelerometers are often used for short-term navigation and the detection of fine movement signatures and features (such as limb movement). Accelerometers can be used to determine orientation with respect to the Earthâ [symbol] ™s gravity as components of gravity are aligned orthogonal to the accelerometer axis. In the dynamic sports environment, complex physical parameters are measured and observed in relation to running and stride characteristics (Herren, Sparti, Aminian and Shultz 1999), and in the determination of gait (Williamson and Andrews 2001). Researchers have also used accelerometers for determining physical activity and effort undertaken by subjects. These kinematics systems have been able to offer comparable results to expensive optical based systems (Mayagoitia, Nene and Veltink 2002). Rate gyroscopes, a close relative of the accelerometer, measure angular acceleration about a single axis and are also used to determine orientation in an angular co-ordinate system, although these suffer from not being able to determine angular position in the same way accelerometers have trouble with absolute position. Additionally many physical movements, such as lower limb movement in sprinting, exceed the maximum specifications in commercially available units that are sufficiently small and inexpensive for such applications.

Generally, motion analysis data collection protocols, measurement precision, and data reduction models have been developed to meet the requirements for their specific settings. For example, sport assessments generally require higher data acquisition rates because of increased velocities compared to normal walking. In virtual reality applications, real-time tracking is essential for a realistic experience of the user, so the time lag should be kept to a minimum. Years of technological development has resulted into many systems can be categorized in mechanical, optical, magnetic, acoustic and inertial trackers. The human body is often considered as a system of rigid links connected by joints. Human body parts are not actually rigid structures, but they are customarily treated as such during studies of human motion.

Optical sensing encompasses a large and varying collection of technologies. Image-based systems determine position by using multiple cameras to track predetermined points (markers) on the subject's body segments, aligned with specific bony landmarks. Position is estimated through the use of multiple 2D images of the working volume. Stereometric techniques correlate common tracking points on the tracked objects in each image and use this information along with knowledge concerning the relationship between each of the images and camera parameters to calculate position. The markers can either be passive (reflective) or active (light emitting). Reflective systems use infrared (IR) LED's mounted around the camera lens, along with IR pass filters placed over the camera lens and measure the light reflected from the markers. Optical systems based on pulsed-LED's measure the infrared light emitted by the LED's placed on the body segments. Also camera tracking of natural objects without the aid of markers is possible, but in general less accurate. It is largely based on computer vision techniques of pattern recognition and often requires high computational resources. Structured light systems use lasers or beamed light to create a plane of light that is swept across the image. They are more appropriate for mapping applications than dynamic tracking of human body motion. Optical systems suffer from occlusion (line of sight) problems whenever a required light path is blocked. Interference from other light sources or reflections may also be a problem which can result in so-called ghost markers.

Magnetic motion capture systems utilize sensors placed on the body to measure the low-frequency magnetic fields generated by a transmitter source. The transmitter source is constructed of three perpendicular coils that emit a magnetic field when a current is applied. The current is sent to these coils in a sequence that creates three mutually perpendicular fields during each measurement cycle. The 3D sensors measure the strength of those fields which is proportional to the distance of each coil from the field emitter assembly. The sensors and source are connected to a processor that calculates position and orientation of each sensor based on its nine measured field values. Magnetic systems do not suffer from line of sight problems because the human body is transparent for the used magnetic fields. However, the shortcomings of magnetic tracking systems are directly related to the physical characteristics of magnetic fields. Magnetic fields decrease in power rapidly as the distance from the generating source increases and so they can easily be disturbed by (ferro)magnetic materials within the measurement volume. Acoustic tracking systems use ultrasonic pulses and can determine position through either time-of-flight of the pulses and triangulation or phasecoherence. Both outside-in and inside-out implementations are possible, which means the transmitter can either be placed on a body segment or fixed in the measurement volume. The physics of sound limit the accuracy, update rate and range of acoustic tracking systems. A clear line of sight must be maintained and tracking can be disturbed by reflections of the sound.

### Ambulatory Tracking:

Commercial optical systems such as Vicon (reflective markers) or Optotrak (active markers) are often considered as a ‘standard’ in human motion analysis. Although these systems provide accurate position information, there are some important limitations. The most important factors are the high costs, occlusion problems and limited measurement volume. The use of a specialized laboratory with fixed equipment impedes many applications, like monitoring of daily life activities, control of prosthetics or assessment of workload in ergonomic studies. In the past few years, the health care system trend toward early discharge to monitor and train patients in their own environment. This has promoted a large development of non-invasive portable and wearable systems. Inertial sensors have been successfully applied for such clinical measurements outside the lab. Moreover, it has opened many possibilities to capture motion data for athletes or animation purposes without the need for a studio.

The orientation obtained by present-day micromachined gyroscopes typically shows an increasing error of degrees per minute. For accurate and drift free orientation estimation Xsens has developed an algorithm to combine the signals from 3D gyroscopes, accelerometers and magnetometers. Accelerometers are used to determine the direction of the local vertical by sensing acceleration due to gravity. Magnetic sensors provide stability in the horizontal plane by sensing the direction of the earth magnetic field like a compass. Data from these complementary sensors are used to eliminate drift by continuous correction of the orientation obtained by angular rate sensor data. This combination is also known as an attitude and heading reference system (AHRS). For human motion tracking, the inertial motion trackers are placed on each body segment to be tracked. The inertial motion trackers give absolute orientation estimates which are also used to calculate the 3D linear accelerations in world coordinates which in turn give translation estimates of the body segments. Since the rotation from sensor to body segment and its position with respect to the axes of rotation are initially unknown, a calibration procedure is necessary. An advanced articulated body model constraints the movements of segments with respect to each other and eliminates any integration drift.

### Medical Gait Analysis of Movement (Kinetics):

Kinematics can be recorded using a variety of systems and methodologies. Photography is the most basic method for the recording to movement and strobe lighting at known frequency has been used in the past to aid in the analysis of gait on single photographic images.

Video recordings using footage from single or multiple cameras can be used to measure joint angles and velocities. This method has been aided by the development of analysis software that greatly simplifies the analysis process and allows for analysis in three dimensions rather than two dimensions only.

Passive marker systems, using reflective markers (typically reflective bails), allow for very accurate measurement of movement using multiple cameras (typically up to eight cameras simultaneously). The cameras send out infra red light signals and detect the reflection from the markers placed on the body. Based on the angle and time delay between the original and reflected signal triangulation of the marker in space is possible. These are typically used for motion capture in movies.

Active marker systems are similar to the passive marker system but use “active” markers. These markers are triggered by the incoming infra red signal and respond by sending out a corresponding signal of their own. This signal is then used to triangulate the location of the marker. The advantage of this system over the passive one is that individual markers work at predefined frequencies and therefore, have their own “identity”. This means that no post-processing of marker locations is required, however the systems tend to be less forgiving for out-of-view markers than the passive systems

A typical modern gait lab has several cameras (video or infra-red) placed around a walkway or treadmill, which are linked to a computer. The patient has markers applied to anatomical landmark points, which are mostly palpable bony landmarks such as the iliac spines of the pelvis, the malleoli of the ankle, and the condyles of the knee. The patient walks down the walkway or on the treadmill and the computer calculates the trajectory of each marker in three dimensions. A model is applied to compute the underlying motion of the bones. This gives a full breakdown of the motion at each joint. In addition, to calculate movement kinetics, most labs have floor load transducers, also known as force-plates, which measure the ground reaction force, including both magnitude and direction. Adding this to the known dynamics of each body segment, enables the solution of equations based on Newton's laws of motion and enables the computer to calculate the forces exerted by each muscle group, and the net moment about each joint at every stage of the gait cycle. The computational method for this is known as inverse dynamics.

This use of kinetics however does not result in information for individual muscles but muscle groups, such as the extensor or flexors of the limb. To detect the activity and contribution of individual muscles to movement, it is necessary to investigate the electrical activity of muscles. Some labs also use surface electrodes attached to the surface of the skin to detect the activity of, for example, a muscle of the leg. In this way it is possible to investigate the activation times of muscles and, to some degree, the magnitude of their activation—thereby assessing their contribution to gait. Deviations from normal kinematic, kinetic or EMG patterns are used to diagnose specific conditions and predict the outcome of treatment.

### Motion Capture:

Specific hardware and special programs are required to obtain and process the data for motion capture. The cost of the software and equipment, personnel required can be prohibitive for small productions. The capture system may have specific requirements for the space it is operated in depending on camera field of view or magnetic distortion.

When problems occur it is easier to reshoot the scene rather than trying to manipulate the data. Only a few systems allow real time viewing of the data to decide if the take needs to be redone. The initial results are limited to what can be performed within the capture volume without extra editing of the data. Movement that does not follow the laws of physics generally cannot be captured.

Traditional animation techniques such as added emphasis on anticipation and follow through, secondary motion or manipulating the shape of the character as with squash and stretch animation techniques must be added later. If the computer model has different proportions from the capture subject, artifacts may occur. For example, if a cartoon character has large, over-sized hands, these may intersect the character's body if the human performer is not careful with their physical motion.

### BEST MODE FOR CARRYING OUT INVENTION

The sport of ice hockey involves addressing special considerations when evaluating the performance of a hockey player

Currently the best practice available for evaluating the ice skating techniques of hockey players is to use an accelerometer affixed to an ice skate in conjunction with high speed video cameras. The results are far from satisfactory and the end result is that a subjective evaluation is required. Further, there tends to be a substantial excess of unwanted data, both from the accelerometer and from the video cameras. These techniques are currently being used by the top professional coaches and consultants for professional hockey players and teams; they have been in use for more than a decade.

The present invention solves this problem by; (1) acquiring only the information which is critical to making an effective evaluation, (2) utilizing the information in the form of a three dimensional closed loop, defined as a leaf trace, which represents the movement of the ice skate during a power stroke. A power stroke is defined as the circular motion of an ice skate to the side which results in the increase of the forward velocity of an ice skater. Additional factors which assist in this evaluation is the capture of data for determining the (1) velocity, acceleration and deceleration of the ice skate along the leaf trace and (2) the spatial orientation of the ice stake as it creates the leaf trace. It is the determination of the actual shape of the leaf trace in three dimensions that is critical. Professional coaches and consultants concur that there is only one correct leaf trace for an ice skate used by a hockey player that provides an optimum result. Currently there are no analytic tools available to acquire user information and to compare it with a correct leaf trace. The orientation of an ice skate during the creation of a leaf trace is also of value.

For convenience, the initial position of an ice skate can be determined by establishing a fixed frame of reference however this is not essential. Also, the length of the ice skater's leg from the hip and from the knee to the ankle can be determined and used in the evaluation however this is not essential. There is some benefit however in being able to compare the power stroke of one ice skate with the position of the other ice skate while it remains in contact with the ice. The use of video cameras in association with the process is optional and is not critical to making an evaluation. The availability and use of velocity and/or acceleration data for a power stroke is helpful but is not critical to the making an effective evaluation. The needed reference data is a correct leaf trace data for one ice skate.

The present invention provides an improved approach to assist in the evaluation of the ice skating techniques of hockey players. Specifically, the improvements are (1a) to capture and present data regarding the path of a leaf trace and/or (1b) to capture and present data regarding the spatial orientation of an ice skate as a leaf trace is created and (2) to avoid capturing additional, unnecessary information. When used with both ice skates, the present invention also allows the comparison of the power stroke of one ice skate with the position of the other ice skate while remains in contact with the ice.

The best mode for the present invention is the use of an inertial sensor affixed to an ice skate with a direct connection to a processor with the processor then extracting the needed information required to document the leaf trace and/or the spatial orientation of the ice skate. The data and the display of the data both have value when evaluating the power stroke of an ice skater. The computer program needed to process the acquired information and present the needed results would be obvious to one skilled in the art of computer programming.

To understand the range of applications and the details of implementing the preferred embodiment of the present invention, reference is made to the drawings. Referring particularly to the figures wherein like-referenced numbers have been applied to like-functions throughout the description as illustrated in the drawings.

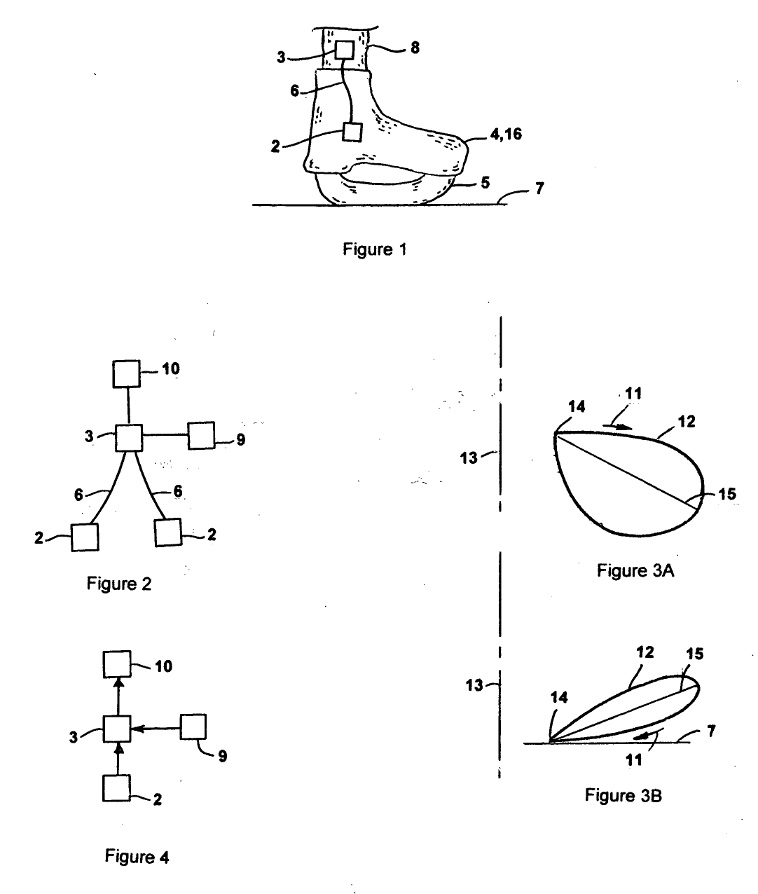

Referring now to FIG. 1, which shows a schematic side view of an ice skate 16, shown worn by an ice skater 8 on the right foot, at least one transducer 2 affixed to said ice skate 16 on the side of the boot 4, said ice skate 16 having a blade 5 affixed to the bottom of said boot 4, a connection 6 from said transducer 2 to a processor 3, said processor 3 affixed to or transported by said ice skater 8, said blade 5 resting on a surface 7.

Referring now to FIG. 2 which shows a schematic drawing of said processor 3 connected to two of said at least one transducers 2, one of said at least one transducer 2 affixed to said ice skate 16 and another affixed to the other ice skate 16, said two transducers 2 each connected by a connector 6 to said processor 3, said processor 3 communicating with a display 10 and with a data source 9.

Referring now to FIGS. 3A and 3B which respectively show schematic top and rear views of a user leaf trace 12 of said ice skate 16 on a right foot during a power stroke, a forward point 14 shown in both views at the bottom forward portion of said leaf trace 12, a median line 15 shown from said forward point 14 and extended centrally to the rear of said leaf trace 12 and a central axis 13 of and through the ice skater shown to one side.

Referring now to FIG. 4 which shows a schematic flow diagram with said at least one transducer 2 connected to and communicating data to said processor 3, said processor 3 communicating with said display 10 and said data source 9.

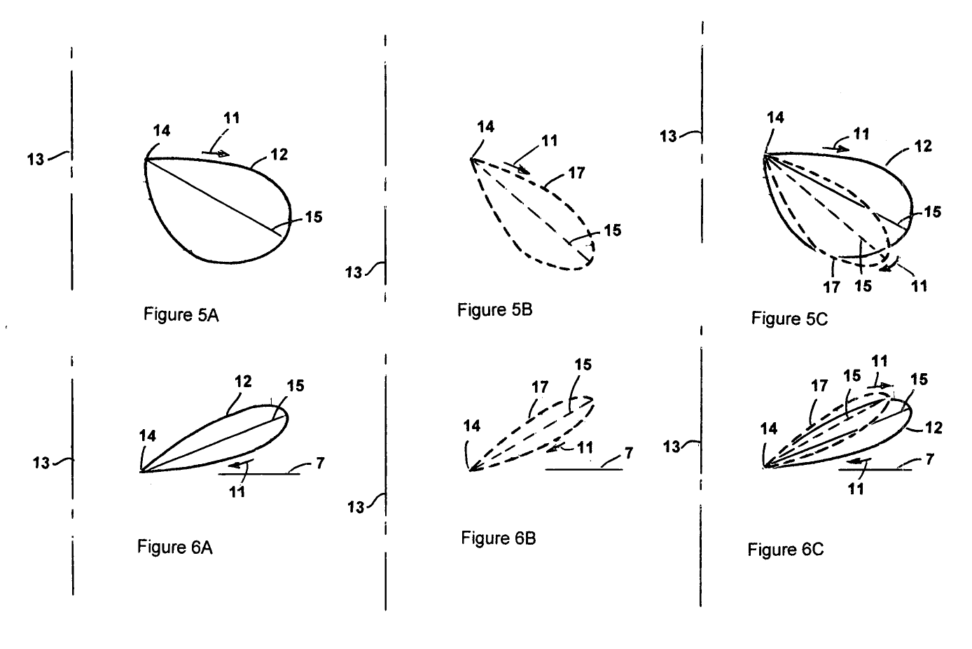

Referring now to FIG. 5A which shows a plan view of said user leaf trace 12 for said ice skate 16. Referring now to FIG. 5B which shows a plan view of said a correct leaf trace 17 for said ice skate 16; shown with dashed lines. Referring now to FIG. 5C which shows a superimposed plan view of both said correct leaf trace 17 and said user leaf trace 12 for said ice skate 16 with said forward point 14 for each of said leaf traces 12,17 superimposed.

Referring now to FIG. 6A which shows a rear view of said user leaf trace 12 for said ice skate 16. Referring now to FIG. 6B which shows a rear view of said correct leaf trace 17 for said ice skate 16; shown with dashed lines. Referring now to FIG. 6C which shows a superimposed rear view of both said correct leaf trace 17 and said user leaf trace 12 for said ice skate 16 with said forward point 14 for each of said leaf traces 12,17 superimposed.

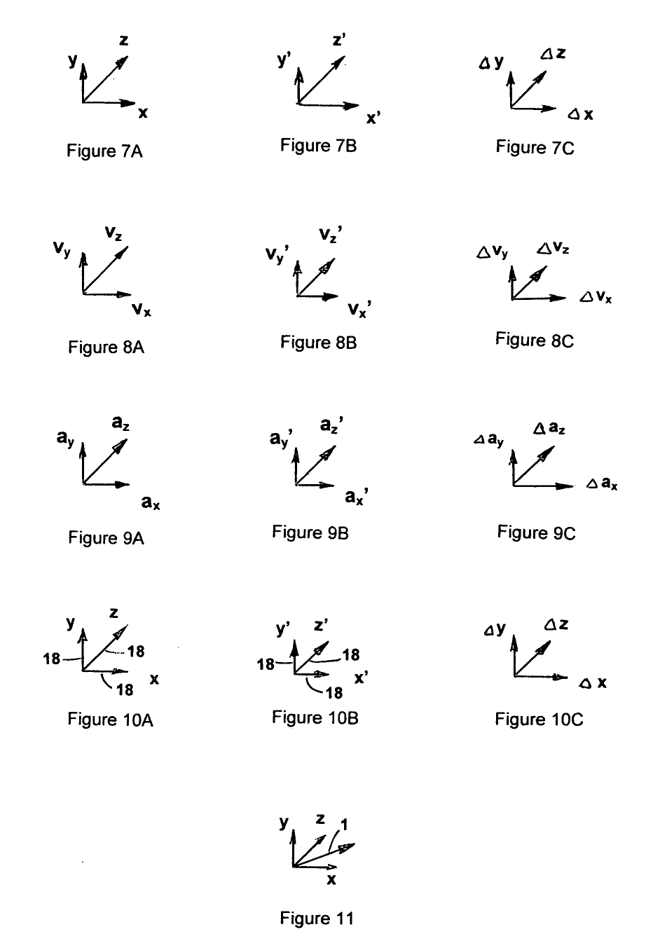

Referring now to FIG. 7A which shows a three dimensional vector diagram of the position of a first point on said correct leaf trace 17. Referring now to FIG. 7B which shows a three dimensional vector diagram of the position of said first point on said user's leaf trace 17. Referring now to FIG. 7C which shows a three dimensional vector diagram of the difference in position between said correct leaf trace 17 and said user's leaf trace 12 at said first point.

Referring now to FIG. 8A which shows a three dimensional vector diagram of the velocity of a first point on said correct leaf trace 17. Referring now to FIG. 8B which shows a three dimensional vector diagram of the velocity of said first point on said user's leaf trace 17. Referring now to FIG. 8C which shows a three dimensional vector diagram of the difference in velocity between said correct leaf trace 17 and said user's leaf trace 12 at said first point.

Referring now to FIG. 9A which shows a three dimensional vector diagram of the acceleration of a first point on said correct leaf trace 17. Referring now to FIG. 9B which shows a three dimensional vector diagram of the acceleration of said first point on said user's leaf trace 17. Referring now to FIG. 9C which shows a three dimensional vector diagram of the difference in acceleration between said correct leaf trace 17 and said user's leaf trace 12 at said first point.

Referring now to FIG. 10A which shows a three dimensional vector diagram of the spatial orientation of said ice skate at a first point on said correct leaf trace 17 with spatial orientation vectors 18. Referring now to FIG. 10B which shows a three dimensional vector diagram of the spatial orientation of said ice skate at said first point on said user's leaf trace 17 with spatial orientation vectors 18. Referring now to FIG. 10C which shows a three dimensional vector diagram of the difference in spatial orientation of said ice skate between said correct leaf trace 17 and said user's leaf trace 12 at said first point with spatial orientation vectors 18. Said spatial orientation vectors 18 being orthogonal vectors.

Referring now to FIG. 11 which shows a single vector 1 in three dimensions, said representation being the equivalent to any of the sets of three vectors shown in orthogonal component form in FIGS. 7-10.

The means for implementing the present invention described as follows:

Said at least one transducer 2 operative to detect movement of said user 8; said processor 3 connected by said connector 6 to said at least one transducer 2 and operative to process, while the user 8 is ice skating, the output of said at least one transducer 2; said processor 3 operative to: assess said output of said at least one transducer 2; and process said output to determine the characteristics of the user's 8 ice skating motions; said at least one transducer 2 affixed to an ice skate worn by the user 8; said processor 3 transported by the user 8, whereby said determinations include determination of leaf trace 12 data and/or spatial orientation 18 data of said ice skate 16 during a power stroke of said ice skate 16; further, said at least one transducer 2 comprised of an inertial sensor; further, said processor 3 operative to process the output of said at least one transducer 2 as the output is received, further said at least one transducer 2 is one transducer 2 affixed to one ice skate 16 and a second transducer 2 affixed to the other ice skate 16 with said processor 3 operative to process the output of both transducers 2 as the output is received, further, with said processor 3, the characteristics of the ice skater's motions for one skate are determined relative to the other skate; further said processor 3 further comprising said display 10 wherein said processor 3 is operative to direct said display 10 to display the determined characteristics of the user's 8 ice skating motions; further, said processor 3 further comprising; said data source 9 accessed by said processor 3, relevant data provided by said data source 9, wherein said processor 3 is operative to correlate said relevant data with said leaf trace 12 data and/or spatial orientation 18 data; further, said processor 3 further comprising said display 10 and said processor 3 operative to direct said display 10 to display said correlations.

The means for implementing the present invention further described as follows:

Said processor 3 operative to accept and process said data while said user 8 is ice skating, whereby said data includes dynamic motion data and/or orientation data derived from at least one ice skate 16 worn by said user 8; said processor 3 being (1) attached to or carried by said user 8, or (2) attached to the user's clothing or to said ice skate 16; said processor 4 further comprising said display 10, wherein said processor 3 is operative to direct said display 10 to display said dynamic motion data and/or said orientation data.

### OPERATION OF THE PRESENT INVENTION

The means for implementing the present invention further described by a method as follows:

A method for detecting the movement of a user comprised of the following steps: the step of having at least one transducer 2 operative to detect movement of a user 8; the step of having a processor 3 and connecting said processor 3 to said at least one transducer 2; the step of having said processor 3 operative to process, while the user 8 is ice skating, the output of said at least one transducer 2, the step of having said processor 3 operative to assess said output of said at least one transducer 2; the step of having said processor 3 process said output, said processor 3 determining the characteristics of the user's 8 ice skating motions; the step of affixing said at least one transducer 2 affixed to an ice skate 16 the step of having said ice skate 16 worn by the user 8; the step of having said processor 3 transported by the user 8, the step of determining leaf trace data and/or spatial orientation data of said ice skate 16 during a power stroke of the ice skate 16, further, the step of having at least one transducer 2 comprised of at least one inertial sensor; further, the step of having said processor 3 operative to process said output is processing said output as it is received; further, the step of having at least one transducer 2 operative to detect movement of said user 8 is by affixing one transducer 2 to an ice skate 16 and affixing a second transducer 2 to the other ice skate 16 and wherein the step of having said processor 3 operative to process the output is processing the output of both transducers 2 as it is received; further, the step of determining characteristics of the ice skater's 8 motions are determining the characteristics of one skate 16 relative to the other skate 16; further, the step of having said processor 3 process said output is further comprising having said display 10 wherein said processor 3 is directing said display 10 to display the determined characteristics of the user's 8 skating motions; further, the step of having said processor 3 process said output is further comprising providing said data source 9 of relevant data, wherein said processor 3 is operative correlating said relevant data with said leaf trace 12 data and/or spatial orientation 18 data; further, said display 10 wherein the step of having said processor 3 process said output is further comprising having the processor direct the display to display said correlations.

Restated, said at least one transducer 2 is attached to said ice skate 16 and connected with said connector 6 to said processor 3, which may be a computer; said user 8 skates creating said leaf trace 12; said at least one transducer 2, typically an accelerometer, sends dynamic motion data and spatial orientation data to said processor 3; correct dynamic motion data and spatial orientation data are accessed from said data source 9 by said processor 3 and correlations are made between the data sets and displayed on said display 10; said correlations include the superimposition of the two leaf traces and plotting the differences in position, velocity, acceleration and/or the orientation of the skate 16 along a leaf trace 12, 17.

The resulting means and method are an improvement over current techniques for analyzing the power stokes of hockey players. All of the above are only some of the examples of available embodiments of the present invention. For example, the present invention can be the means to create a business in which evaluations of this type are made for profit and in such case, supervision and/or evaluations by a professional, on a continuing basis, may or may not be utilized. Further, a wide variety of techniques are available to present the vectors. Those skilled in the art will readily observe that numerous other modifications and alterations may be made without departing from the spirit and scope of the invention. Accordingly, the above disclosure is not intended as limiting and the appended claims are to be interpreted as encompassing the entire scope of the invention.

### REFERENCE NUMERALS

| Numeral | Description |
|---|---|
| 1. | Vector |
| 2. | Transducer |
| 3. | Processor |
| 4. | Skate boot |
| 5. | Skate blade |
| 6. | Connection |
| 7. | Ice surface |
| 8. | User |
| 9. | Data source |
| 10. | Display |
| 11. | Motion arrow |
| 12. | Leaf trace, user |
| 13. | Center line |
| 14. | Forward bottom point on leaf trace |
| 15. | Median |
| 16. | Ice skate |
| 17. | Correct leaf trace |
| 18. | Spatial orientation vector |

What is claimed is:

1. At least one transducer operative to detect movement of a user; a processor connected to said at least one transducer and operative to process, while the user is ice skating, the output of said at least one transducer, said processor operative to: assess said output of said at least one transducer; and process said output to determine the characteristics of the user's ice skating motions; said at least one transducer affixed to an ice skate worn by the user; said processor transported by the user, whereby said determinations include determination of leaf trace data and/or spatial orientation data of said ice skate during a power stroke of the ice skate.

2. Said at least one transducer of claim 1, wherein said at least one transducer comprises at least one inertial sensor.

3. The processor claim 1, wherein the processor is operative to process the output of said at least one transducer as the output is received.

4. Said at least one transducer of claim 1 whereby said at least one transducer is one transducer affixed to one ice skate and a second transducer affixed to the other ice skate.

5. The processor of claim 4 wherein the processor is operative to process the output of both transducers as the output is received.

6. The processor of claim 4 wherein the determined characteristics of the ice skater's motions are the characteristics of one skate relative to the other skate.

7. The processor of claim 1 further comprising: a display wherein the processor is operative to direct the display to display the determined characteristics of the user's ice skating motions.

8. The processor of claim 1 further comprising; a data source accessed by the processor, relevant data provided by said data source, wherein the processor is operative to correlate said relevant data with said leaf trace data and/or spatial orientation data.

9. The processor of claim 8 further comprising: a display wherein the processor is operative to direct the display to display said correlations.

10. A processor for processing data derived from the characteristics of a user's ice skating motions, said processor operative to accept and process said data while a user is ice skating, whereby said data includes dynamic motion data and/or orientation data derived from at least one ice skate worn by a user.

11. A processor as in claim 10, wherein the processor is (1) attached to or carried by the user, or (2) attached to the user's clothing or to an ice skate.

12. A processor as in claim 10 further comprising a display, a display wherein the processor is operative to direct the display to display said dynamic motion data and/or said orientation data.

13. A method for detecting the movement of a user comprised of the following steps:
the step of having at least one transducer operative to detect movement of a user;
the step of having a processor and connecting said processor to said at least one transducer;
the step of having said processor operative to process, while the user is ice skating, the output of said at least one transducer,
the step of having said processor operative to assess said output of said at least one transducer;
the step of having said processor process said output, said processor determining the characteristics of the user's ice skating motions;
the step of affixing said at least one transducer affixed to an ice skate the step of having said ice skate worn by the user;
the step of having said processor transported by the user,
the step of determining leaf trace data and/or spatial orientation data of said ice skate during a power stroke of the ice skate.

14. The method of claim 13 wherein the step of having at least one transducer comprises at least one inertial sensor.

15. The method of claim 13 wherein the step of having said processor operative to process said output is processing said output as it is received.

16. The method of claim 13 wherein the step of having at least one transducer operative to detect movement of a user is by affixing one transducer to an ice skate and affixing a secon transducer to the other ice skate.

17. The method of claim 16 wherein the step of having said processor operative to process the output is processing the output of both transducers as it is received.

18. The method of claim 16 wherein the step of determining characteristics of the ice skater's motions are determining the characteristics of one skate relative to the other skate.

19. The method of claim 13 wherein the step of having said processor process said output is further comprising having a display wherein the processor is directing the display to display the determined characteristics of the user's skating motions.

20. The method of claim 13 wherein the step of having said processor process said output is further comprising providing a data source of relevant data, wherein the processor is operative correlating said relevant data with said leaf trace data and/or spatial orientation data.

21. The method of claim 20 further comprising: a display wherein the step of having said processor process said output is further comprising having a display wherein the processor is directing the display to display said correlations.
